(19) United States
(12) Patent Application Publication
(10) Pub. No.: US 2014/0096447 A1
(43) Pub. Date: Apr. 10, 2014

(54) PERSONNEL ACCESS-CONTROL DEVICE IN THE FORM OF A TURNSTILE

(71) Applicant: SKIDATA AG, Grodig/Salzburg (AT)

(72) Inventors: GUIDO HARUCKSTEINER, Eugendorf (AT); Markus Leitner, Rohrdorf (DE); Reinhard Surkau, Traunstein (DE)

(73) Assignee: SkiData AG, GRODIG/SALZBURG (AT)

(21) Appl. No.: 13/799,320

(22) Filed: Mar. 13, 2013

(30) Foreign Application Priority Data
Oct. 4, 2012 (EP) 12187146.1

(51) Int. Cl. E06B 11/08; E05F 15/20

(52) U.S. Cl. CPC E06B 11/08; E05F 15/2023
USPC 49/31; 49/46

(57) ABSTRACT

A personnel access-control device in the form of a turnstile (1) has one or more blocking arms (2, 3) connected to a main shaft (5) mounted in a carrier (4). The blocking arms (2, 3) assume a blocking position and at least one free position in dependence upon the rotation of the main shaft (5). Each blocking arm (2, 3) includes a flat component (6, 7) that is mounted to rotate about its longitudinal axis (8, 9) in dependence upon the rotation of the main shaft (5). In the blocking position of the blocking arms (2, 3), a pre-defined angular position of the flat component (6, 7) with respect to the perpendicular direction is achieved, and in the free position, the flat component (6, 7) is rotated such that passage of a person is allowed and/or that the passage width is not limited.

### BACKGROUND OF THE INVENTION

The invention relates to a personnel access-control device in the form of a turnstile for controlling access to a defined area.

Personnel access-control devices are well known in the prior art. For example, a device is known from EP 1 023 608 B1 in which an antenna unit for communication with an RFID (radio-frequency identification device) transponder acts as data medium in which access authorization is stored. Personnel access-control devices further includes a blocking device actuated via a control circuit by an actuator in order to allow a person to enter or exit a building or controlled space. For this, the blocking device is released from a blocking position into a free position upon readout of a valid access authorization. In the free position, access is provided to a person, and/or the width of a passage is not restricted. In contrast, access is denied in the blocking position. In such access-control devices, a turnstile is often used as the blocking device.

Turnstiles as known in the art include a main shaft directed downward that is mounted on a carrier, and to which, for example, three blocking arms are affixed. Alternatively, the main shaft may include one or two blocking arms. The pivot axis of the main shaft is advantageously inclined at 30° to 60° to the horizontal, particularly at 45°, whereby the angle of the blocking arms to the pivot axis is 30° to 60°, and advantageously 45°. In a projection to the plane perpendicular to the pivot axis, the angle between the blocking arms for three blocking arms is 120°, and 180° for two blocking arms. Tilting of the pivot axis reduces the direct angle between blocking arms (˜83° with 3 blocking arms, ˜80° with 2 blocking arms).

Furthermore, the carrier to which the main shaft is mounted may be implemented as a post to which is secured a reader device that, upon read-out of a valid access authorization, triggers an actuator to rotate the main shaft and thus to provide access.

In the case of access-control devices for personnel that read access authorizations from RFID transponders without contact, the reader device includes a housing with an antenna unit oriented along the passage direction and advantageously extending from above to below in order to be able to read the RFID transponder. For this, a suitable electronic circuit to control the antenna unit may also be mounted within this housing.

The laterally-positioned RFID antenna units known in the art are disadvantageously expensive and require substantial installation space. Furthermore, concentrating the electromagnetic or magnetic field based on the volume of passing persons, and thus reducing signal cross-talk to and from adjacent access points, is linked to considerable expense. Screening measures required to accomplish this cause a significant redaction in the identification range, and must be carefully compensated using suitable electronic means.

Disadvantageously, using known personnel control devices that use laterally-mounted RFID antenna units may detect persons in adjacent access points, or may detect several persons standing in line from electromagnetic or magnetic fields of the antenna units, which detracts from the function of access-control devices and from user convenience.

### SUMMARY OF THE INVENTION

A principal object of the present invention is to provide a personnel access-control device, implemented as a turnstile, in which the above-mentioned disadvantages of access-control devices known in the art are avoided. The turnstile must include blocking arms with large surface areas without limiting the passage width. Furthermore, the use of laterally-mounted RFID antenna units is to be avoided, allowing the electromagnetic or magnetic fields to be concentrated in the region of the persons that pass through.

Furthermore, the personnel access-control device based on the invention must enable additional functions such as, for example, a high-visibility advertising surface or integrated illumination.

These objectives, as well as further objectives which will became apparent from the discussion that follows, are achieved, in accordance with the present invention, by providing a personnel access-control device, implemented as a turnstile, that includes one, two, or three blocking arms connected to a main shaft mounted on a carrier, whereby the blocking arms assume a blocking position and at least one free position in dependence upon the rotation of the main shaft.

Based on the invention, each of the blocking arms possesses a flat component part that is mounted to rotate about the longitudinal axis of the arm. Rotation of the flat component occurs about this longitudinal axis in dependence upon the rotation of the main shaft in such a manner that, in the blocking position of the blocking arm, a pre-defined angular position of the flat component with respect to the perpendicular direction is achieved, and the flat component is rotated to at least one free position such that passage of a person is allowed and/or that the passage width is not limited.

The flat components of the blocking arms may be paddle-shaped, rectangular, elliptical, or otherwise configured, perhaps in accordance with an associated activity such as a snowboard.

The rotary motion of the flat components about the longitudinal axis of the blocking arms based on the invention may be controlled electro-mechanically, mechanically via connecting-link guides, or via a transmission functionally connected with the main shaft. When the angular velocity of the rotary motion of the flat components about the longitudinal axis of the blocking arms is advantageously half the angular velocity of the rotary motion of the main shaft, then the rotary motion of the flat components about the longitudinal axis of the blocking arms with respect to the rotary motion of the main shaft occurs within the first half-rotation of the main shaft in the same or opposite rotational direction of the main shaft, while during the second half-rotation of the main shaft, the rotary motion of the flat components occurs in the opposite or same rotational direction of the main shaft, which ensures that, upon one full rotation of the main shaft, each of the flat components comes to rest in the blocking position along only one rotational direction.

This proves to be particularly advantageous if an RFID antenna unit is incorporated into the flat components of the blocking arms that emits only in the direction perpendicular to the surface of the flat components, since on the one hand, the electromagnetic field of the antenna unit in the blocking position of the blocking arms is always oriented toward the area in which a person for read-out of access authorization is located, and on the other hand, read-out of access authorization of persons who have already passed through is prevented.

One or both sides of the flat components of the blocking arms may be implemented as conventional advertising space including a display. Since the flat components of the blocking arms come to rest in the blocking position along only one rotational orientation, only one display and/or advertising surface needs be provided.

The flat components of the blocking arms may advantageously be dimensioned such that at least one RFID antenna unit, that communicates with RFID transponders implemented as a data medium to read access authorization may be integrated into them, as explained above. According to the invention, the flat components of the blocking arms may be implemented such that an RFID antenna unit may be integrated into the flat components in a shape optimal for transmission and reception, and for function.

In this manner, the installation of laterally-positioned, high-volume antenna units requiring large installation space is avoided.

Furthermore, based on the invention, it may be provided that the flat components of the blocking arms in their blocking position are tilted with respect to the vertical toward the persons whose access authorization is to be read such that the electromagnetic or magnetic field of the antenna unit is essentially directed toward an area corresponding to the normal occupied area of the no-contact readable access authorization of the persons located directly in front of the turnstile.

This allows, on the one hand, targeted concentration of the electromagnetic or magnetic field toward the person located directly in front of the turnstile; and on the other hand, for the case in which the electromagnetic field is not shielded in the opposite direction, or that a magnetic RFID antenna unit is employed whose magnetic field extends in both directions perpendicular to the surfaces, it ensures that the electromagnetic or magnetic field of the antenna unit no longer receives the access authorization of a previous person since, because of the inclination angle of the flat components, the electromagnetic or magnetic field is essentially directed toward areas at the approximate height of the legs, ideally of the lower legs, of the previous person.

Thus, signal cross-talk interference with other persons is avoided. Also, the deletion of the installation of laterally-mounted antennas allows prevention of signal cross-talk to persons in adjacent passage points and/or access-monitoring devices.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic view of a personnel access-control device based on the invention comprising of two blocking arms, whereby one blocking arm is in the blocking position and one blocking arm is in the free position.

FIG. 2 is a perspective view of the personnel access-control device shown in FIG. 1.

FIG. 3 is a perspective view of the embodiment of the personnel access-control device shown in FIG. 2 with arrows to reveal the possibility of rotation of the flat components with respect to the rotation of the main shaft.

FIG. 4 is a perspective view of the invention embodiment shown in FIG. 3, whereby the rotational motion of the main shaft and of the flat components are shown at a later point in time.

FIG. 5 is a schematic view of the invention embodiment shown in FIG. 2 to reveal an additional possibility of rotation of the flat components with respect to the rotation of the main shaft.

FIG. 6 is a schematic view of the invention embodiment shown in FIG. 5, whereby the rotational motions of the main shaft and of the flat components are shown at a later point in time.

### DESCRIPTION OF THE PREFERRED EMBODIMENTS

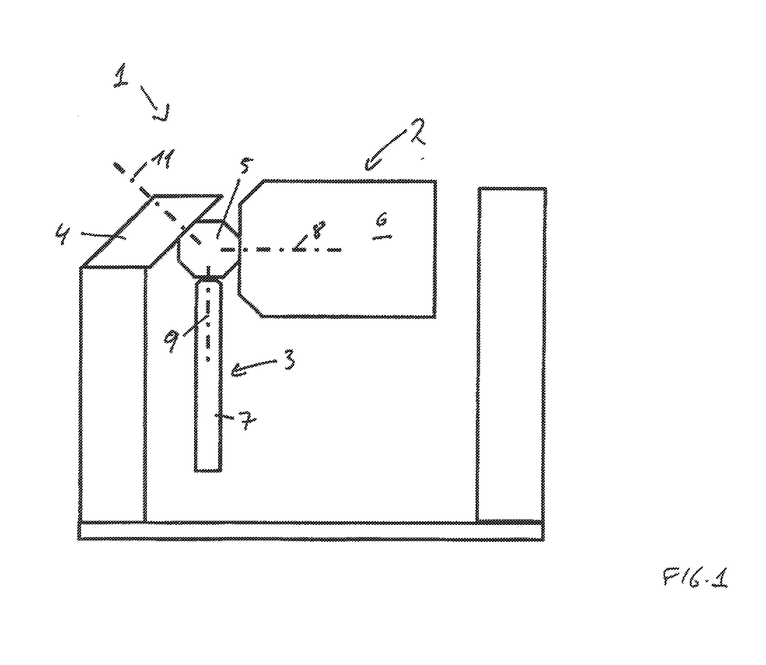

The preferred embodiments of the present invention will now be described with reference to FIGS. 1-6 of the drawings. Identical elements in the various figures are designated with the same reference numerals.

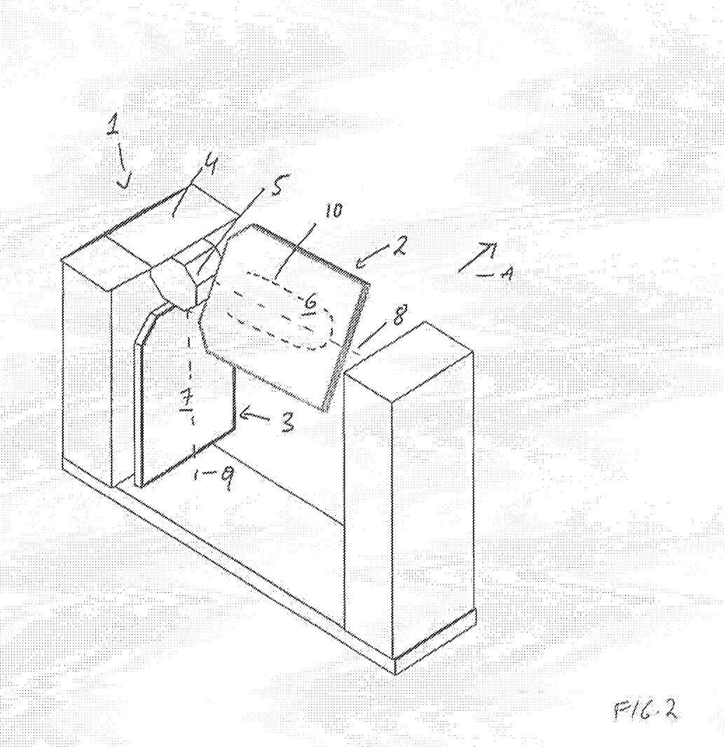

FIGS. 1 and 2 show a turnstile 1 constructed according to the invention. It includes two blocking arms 2, 3 connected with a main shaft 5 mounted on a carrier 4. The blocking arms 2, 3 may each assume a blocking position and a free position depending on the rotation of the main shaft 5. In the embodiment shown in FIG. 1, the first blocking arm 2 is in the blocking position while the second blocking arm 3 is in the free position. For the case in which three blocking arms are provided, they are usually positioned at angular separation of 120° from one another (measured by projecting the arms onto a plane perpendicular to the rotating axis), so that each blocking arm may assume one blocking position and two free positions.

The rotational axis 11 of the main shaft 5 of the of the turnstile 1 is inclined with respect to the horizontal by 30° to 60°, advantageously 45°; the angle of the blocking arms 2, 3 to the rotational axis of the main shaft 5 may be 30° to 60°, advantageously 45°.

Based on the invention, the blocking arms 2, 3 possess flat components 6, 7 that are mounted so that they may rotate about the longitudinal axis 8, 9 of the blocking arms 2, 3, whereby the rotation of the flat components 6, 7 of the blocking arms 2, 3 about the longitudinal axis 8, 9 of the blocking arms 2, 3 occurs dependent on the rotation of the main shaft 5 such that, in the blocking position of the blocking arms, a pre-defined angular position of the flat components with respect to the vertical may be achieved, and in at least one free position, the flat component is rotated such that passage of a person is allowed and/or the passage width is not limited.

As FIGS. 1 and 2 show, the flat component 7 of the second blocking arm 3 in the free position is rotated about the longitudinal axis 9 such that essentially the entire passage width is available, so that, for example, during summer operation of a ski lift, a maximum passage width is established for child strollers, wheelchairs, or mountain bikes. In such applications, only one blocking arm is used as a rule. With reference to FIG. 2, in the blocking position of the blocking arms 2, 3, a pre-defined angular position of the flat components with respect to the vertical may be achieved. In the embodiment shown in FIG. 2, the flat components 6, 7 in the blocking position are inclined to the vertical at a pre-defined angle, as is visible based on the angular position of the flat component 6 of the first blocking arm 2.

The flat components 6, 7 of the blocking arms 2, 3 are implemented with a paddle shape in the embodiment shown in FIGS. 1 and 2. They may be secured to the blocking arms 2, 3 against rotation, whereby in this case the blocking arms 2, 3 are mounted to be rotated about their longitudinal axes 8, 9. Alternatively to this implementation, the flat components 6, 7 of the blocking arms 2, 3 may be mounted on a hollow shaft through which each of the blocking arms 2, 3 is mounted. In this case, the hollow shafts may be rotated.

The rotary motion of the flat components 6, 7 about the longitudinal 8, 9 of the blocking arms 2, 3 may be provided electro-mechanically via common or individual electric motors assigned to each blocking arm and/or hollow shafts onto which the flat components 6, 7 are mounted. Alternatively, the rotary motion of the flat components 6, 7 of the blocking arms 2, 3 about the longitudinal axes 8, 9 of the blocking arms 2, 3 may be mechanically controlled by means of connecting-link guides for the blocking arms and/or for the hollow shafts onto which the flat components are mounted, or by means of a transmission functionally connected to the main shaft 5.

In an advantageous embodiment of the invention, the angular velocity of the rotary motion of the flat components 6, 7 about the longitudinal axes 8, 9 of the blocking arms 2, 3 is half of the angular velocity of the rotary motion of the main shaft 5.

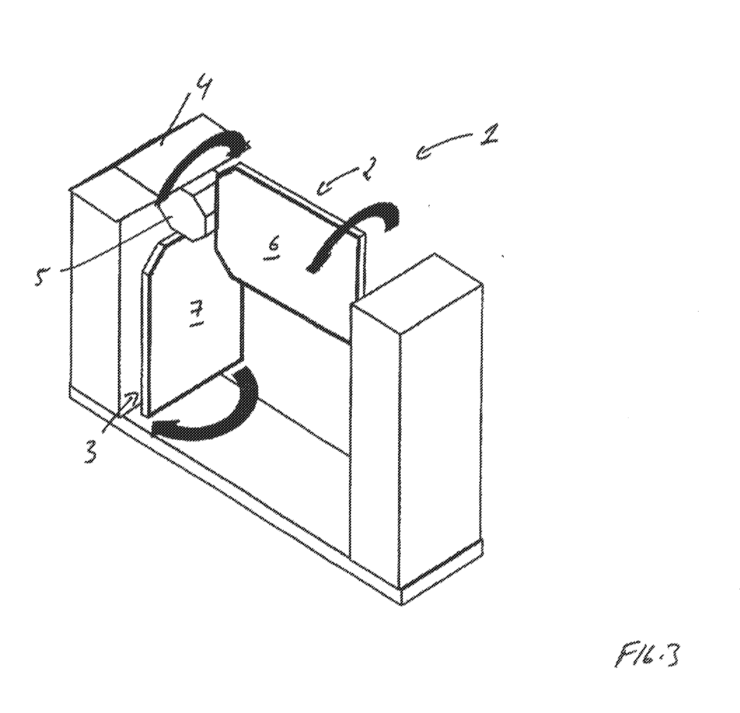

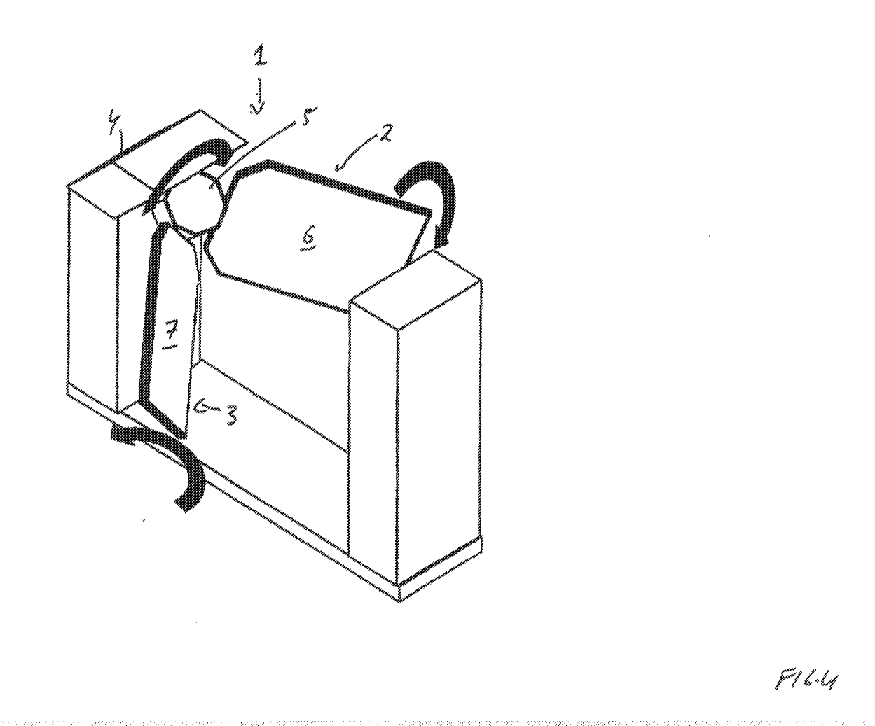

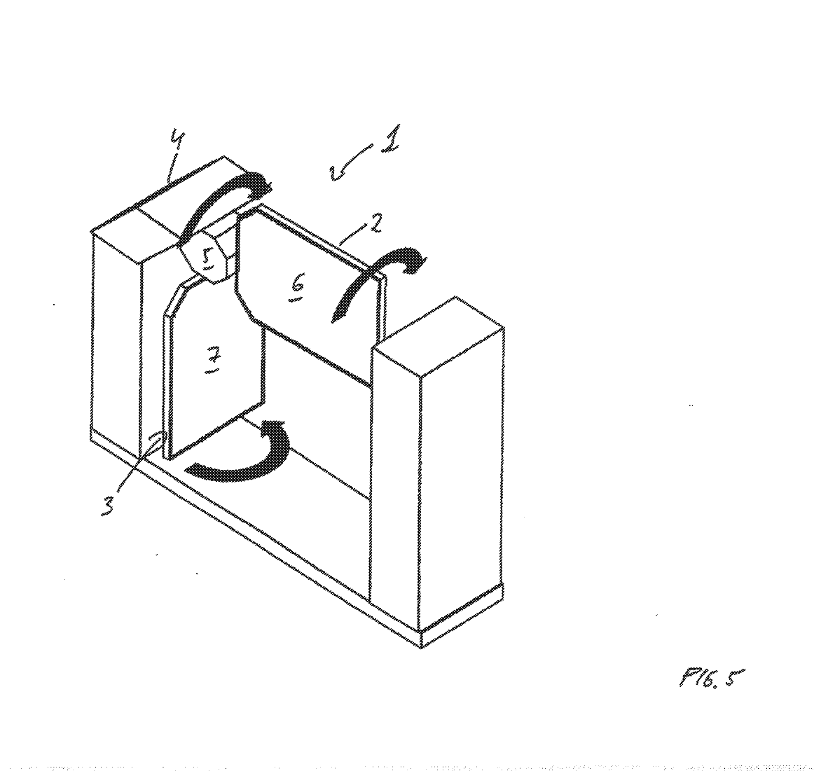

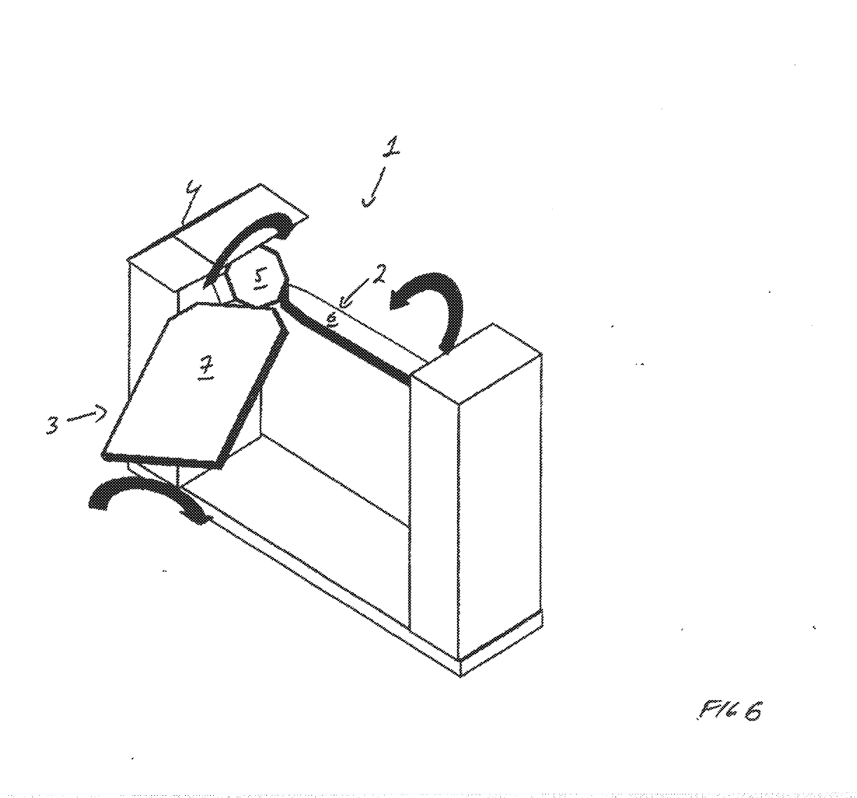

The rotary motion of the flat components 6, 7 about the longitudinal axes of the blocking arms 2, 3 may be with or opposite the direction of rotation of the main shaft 5. In the embodiment shown in FIGS. 3 and 4, the rotary motion of the flat components 6, 7 about the longitudinal axes of the blocking arms 2, 3 are against the direction of the main shaft 5, whereby the embodiment shown in FIGS. 5 and 6, the rotary motion of the flat components 6, 7 about the longitudinal axes of the blocking arms 2, 3 is opposite to the direction of the main shaft 5. FIGS. 2 and 5 each show the point in time immediately after provision of access (the first blocking arm is still in the blocking position, and the second blocking arm 3 is in the free position), whereby FIGS. 4 and 6 each show a later point in time.

It may be provided that the rotary motion of the flat components 6, 7 about the longitudinal axes 8, 9 of the blocking arms 2, 3 based on the invention is not linear with respect to the rotary motion of the main shaft 5. For example, the rotary motion may occur immediately after leaving the blocking position at a lower angular velocity, whereby after rotation of the main shaft 5 by a specified amount, e.g., by 30°, the angular velocity of the rotary motion of the flat components 6, 7 about the longitudinal axes 8, 9 of the blocking arms 2, 3 is increased. Thus, it may be prevented that passing persons come into contact with the flat components 6, 7 because of the rotation of the flat components 6, 7, or that the blocking arm in its free position touches the carrier 4.

In a particularly advantageous embodiment of the invention, it is proposed to integrate at least one RFID antenna unit into the flat components 6, 7 of the blocking arms 2, 3 that communicates with RFID transponders as data medium to read an access authorization, whereby the control of at least one antenna unit may be integrated into the flat components 6, 7. Such an antenna unit is shown in FIG. 2 with dashed lines, and is identified by index symbol 10.

With this, particularly when the angular velocity of the rotary motion of the flat components 6, 7 of the blocking arms 2, 3 about the longitudinal axes 8, 9 of the blocking arms 2, 3 is half that of the rotary motion of the main shaft 5, the rotary motion of the flat components 6, 7 about the longitudinal axis of the blocking arms 2, 3 may occur within the first half-rotation of the main shaft 5 in the same or opposite rotational direction of the main shaft 5, while during the second half-rotation of the main shaft 5, in the opposite or same direction of the main shaft 5 so that, upon one full rotation of the main shaft 5, the flat components 6, 7 come to rest in their blocking position only with one rotational orientation so that the electromagnetic field of at least one antenna unit 10 is always directed toward the area in which a person whose access authorization is to be read is located. This also allows the configuration in which the antenna unit 10 emits merely in the direction perpendicular to the surface of the flat components, advantageously resulting in the fact that read-out of the access authorization of persons who have already passed through is prevented.

This configuration is also particularly advantageous if the flat components 6, 7 of the blocking arms 2, 3 are provided on one side with a conventional or electronic advertising surface in addition to, or as an alternative to, the minimum of one antenna unit 10 since that makes the advertising surface visible to the approaching person. In other embodiments, the flat components 6, 7 of the blocking arms 2, 3 may be provided on both sides with a conventional or electronic advertising surface with a display.

Based on the invention, in addition to, or as an alternative to, the configuration including at least one antenna unit 10 and/or an advertising surface, the flat components 6, 7 of the blocking arms 2, 3 may be illuminated on one or both sides, or a display device may be provided to display digits and/or text-symbol combinations, or symbols. For this, individual LED's, or in the case of a display device, at least one LED circuit board including a large number of individually-controllable RGB-LED's may be integrated whereby the surfaces of the flat components 6, 7 of the blocking arms 2, 3 that may be illuminated and/or that includes a display device are made at least partially of a translucent material such as a plastic polymer, particularly at those locations corresponding to the installed position of at least one LED circuit board and/or individual LED's. The display device may advantageously be configured as a traffic-lane signal. As explained above, since the flat components 6, 7 come to rest in the blocking position with only one rotational orientation, these embodiments ensure that the display device is always on the side facing the approaching person.

For the case in which the flat components 6, 7 include a display device to display digits and/or text-symbol combinations, or symbols, it may also be provided that the surface of the flat components is coated with a full opaque coating on the side facing away from or toward the minimum of one LED circuit board that is removed at locations corresponding to the installed position of the LED's of the at least one LED circuit board, making the display device translucent at these locations.

Control of the individual LED's or of the display device may also be integrated into the blocking arms 2, 3. Furthermore, the control circuit for the electronic advertising surface (if present) may also be integrated.

Furthermore, sensors may also be integrated into the flat components 6, 7 of the blocking arms 2, 3 that detect the presence of a person directly in front of the turnstile and activate the actuator for the turnstile, the electronics to control the antenna unit 10, and display device and/or electronic advertising surface because of the sensor signal.

In reference to FIG. 2, the flat components of the blocking arms in their blocking position are inclined from the vertical toward the persons whose access authorization is to be read such that the electromagnetic or magnetic field of the antenna unit 10 is directed essentially toward an area corresponding to the normal position of person located in front of the turnstile for contact-free access authorization, preferably toward an area between knee and shoulder. In FIG. 2, the passage direction is shown by arrow A.

This enables targeted concentration of the electromagnetic field toward the person located directly in front of the turnstile. Additionally, in the case where the electromagnetic field is not screened in the rearward direction, it ensures that the electromagnetic field of the antenna unit 10 no longer receives the access authorization from a previous a person whom the turnstile has already admitted, since the inclination angle of the flat components aims the electromagnetic field essentially toward areas basically corresponding to the height of the lower leg areas of the previous person. The inclination angle may advantageously possess a value between 0° and 45°.

In another embodiment of the invention, additional sensors may be provided by means of which aiming of the flat components of the blocking arms toward the approaching person may be based on distance and body size or other optional characteristics is possible. For example, sensors may be used that can identify the distance and body size of the approaching person, whereby based on this data, the inclination angle of the flat components in their blocking position are controlled such that the electromagnetic field of the antenna unit essentially corresponds to the normal area of the approaching person for contact-free access authorization, namely between knee and shoulder.

There has thus been shown and described a novel personnel access-control device in the form of a turnstile which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A personnel access control devices in the form of a turnstile having a stationary carrier and a rotatable gate with at least one blocking arm, said gate being mounted for rotation with respect to the carrier about a main shaft such that the blocking arm is movable between a blocking position which blocks access and at least one free position which allows access, the improvement wherein each blocking arm includes a flat component which is mounted to rotate about a longitudinal arm axis in dependence upon the rotation of the gate about the main shaft such that, in said blocking position, said flat component is rotated to a first defined angle with respect to the vertical to present a barrier to a person and, in said free position, the flat component is rotated such that at least one of (a) a passage of a person is allowed and (b) a passage width is not restricted.

2. Personnel access-control device according to claim 1, wherein the flat component has a shape selected from the group consisting of paddle-shaped, rectangular, elliptical and configured to reflect a sport activity.

3. Personnel access-control device in accordance with claim 1, wherein each flat component is fixedly secured to a respective blocking arm, and wherein the blocking arms are mounted for rotation about their longitudinal axes.

4. Personnel access-control device in accordance with claim 1, wherein the flat component is mounted on a hollow shaft by means of which each blocking arm is controlled.

5. Personnel access-control device in accordance with claim 1, wherein the rotary motion of the flat components about the longitudinal axes of the blocking arms is controlled by a device selected from the group consisting of a common electromechanical drive, several separate electromechanical drives, each assigned to a blocking arm, mechanical connecting-link guides, and a transmission operationally connected with the main shaft.

6. Personnel access-control device in accordance with claim 1, wherein the angular velocity of the rotary motion of the flat components about the longitudinal axes of the blocking arms is half the angular velocity of the rotary motion of the main shaft.

7. Personnel access-control device in accordance with claim 1, wherein the rotation of the flat components about the longitudinal axes of the blocking arms is in the same direction as the rotation of the main shaft.

8. Personnel access-control device in accordance with claim 1, wherein the rotation of the flat components about the longitudinal axes of the blocking arms is in an opposite rotational direction to that of the main shaft.

9. Personnel access-control device in accordance with claim 1, wherein the rotary motion of the flat components about the longitudinal axes of the blocking arms is non-linear with respect to the rotational direction of the main shaft.

10. Personnel access-control device in accordance with claim 1, wherein the rotary motion of the flat components about the longitudinal axes of the blocking arms occurs within the first half-rotation of the main shaft in a same or opposite rotational direction to that of the main shaft, and during a second half-rotation of the main shaft, the rotary motion of the flat components occurs in an opposite or same rotational direction to that of the main shaft such that, and upon one full rotation of the main shaft, each of the flat components comes to rest in the blocking position along only one rotational direction.

11. Personnel access-control device in accordance with claim 1, wherein at least one side of the flat components of the blocking arms includes a space for advertising.

12. Personnel access-control device in accordance with claim 11, wherein the advertising space includes an electronic display.

13. Personnel access-control device in accordance with claim 1, wherein the flat components of the blocking arms are illuminated on at least one side.

14. Personnel access-control device in accordance with claim 1, wherein the flat components of the blocking arms are configured such that at least one RFID antenna unit is integrated into the flat component that communicates with RFID transponders implemented as a data medium to read access authorization.

15. Personnel access-control device according to claim 4, wherein the antenna unit is configured with an optimum shape based on transmission and reception characteristics and functionality.

16. Personnel access-control device in accordance with claim 1, wherein at least one side of the flat components of the blocking arms includes a display device for displaying alphanumeric characters and symbols.

17. Personnel access-control device in accordance with claim 12, wherein the flat components of the blocking arms further include a control unit for controlling the display.

18. Personnel access-control device in accordance with claim 14, wherein the flat components of the blocking arms in the blocking position are inclined with respect to the vertical toward persons whose access authorization is to be read, such that the field generated by the antenna unit is directed essentially toward an area corresponding to the normal area occupied by the person located in front of the turnstile, whereby the electromagnetic or magnetic field of the antenna unit does not receive an access authorization of a previous person who has already passed through the turnstile.

19. Personnel access-control device in accordance with claim 18, wherein the flat components of the blocking arms in their blocking position are inclined with respect to the vertical toward persons whose access authorization is to be read, such that a field generated by the antenna unit is directed essentially toward an area between an knee and shoulder of a person located in front of the turnstile.

20. Personnel access-control device in accordance with claim 18, further comprising personnel sensors by means of which orientation of the flat components of the blocking arms is controlled based on body characteristics of an approaching person.
